(19) United States
(12) Patent Application Publication
(10) Pub. No.: US 2011/0262795 A1
(43) Pub. Date: Oct. 27, 2011

(54) BATTERY

(76) Inventors: Joerg Ziegler, Rutesheim (DE); Jens Grimminger, Senden (DE); Niluefer Baba, Stuttgart (DE)

(21) Appl. No.: 13/131,732

(22) PCT Filed: Oct. 6, 2009
(86) PCT No.: PCT/EP2009/062945

§ 371 Date: Jul. 5, 2011

(30) Foreign Application Priority Data
Nov. 28, 2008 (DE) 102008044162.7

(51) Int. Cl. H01M 10/50

(52) U.S. Cl. 429/120

(57) ABSTRACT

The invention relates to a battery having a housing for accommodating at least one electrolyte. The at least one electrolyte is accommodated by the housing. According to the invention, at least one thermal conduction element is arranged in the at least one battery in order to increase the thermal conductivity within the at least one battery.

The present invention relates to a battery as defined by the preamble to claim 1, a battery module as defined by the preamble to claim 13, and a motor vehicle.

### PRIOR ART

Batteries, such as nickel-cadmium, nickel-metal hydride, and in particular lithium-ion batteries, supply various kinds of equipment, such as motor vehicles, hospitals, or power drills, with electric current. In general, a plurality of batteries are installed in one battery module housing and thereby form a battery module. Battery modules have the advantage that they can be more easily tempered with a tempering fluid, and higher levels of electric power can be achieved by the combination of a plurality of battery modules into a battery module system.

German Patent Disclosure DE 602 08 862 T2 shows a prismatic battery with a group of electrode plates, an electrolyte, and a housing of the prismatic battery for accommodating both the group of electrode plates and the electrolyte; a metal plate is embedded integrally in a side wall of the housing of the prismatic battery, and the side wall is disposed parallel to the group of electrode plates. A heat transfer part, which protrudes from the housing of the prismatic battery, is provided on at least one side of the metal plate. Disadvantageously, the battery can accordingly be cooled with the heat transfer part only on the outside, in the vicinity of the housing of the prismatic battery.

European Patent Disclosure EP 1 117 138 A1 shows a cooling device for prismatic batteries, which are combined into a battery module. Side faces of the batteries having the largest surface area are oriented parallel to one another in the battery module, and a metal spacer is disposed between the parallel-oriented side faces of the batteries, so that a cooling medium can be passed between the side faces of the batteries, since the spacer has a corresponding geometry for embodying flow passages. Thus only the side face of the batteries can be cooled.

From US Patent Disclosure 2003/0165734 A1, cooling fins of a thermally conductive material are known, which are disposed between prismatic battery cells. The cooling fins are in contact with the battery cells and conduct the waste heat from the battery cells to a second portion of the cooling fins that is not in contact with the battery cells. In this second portion of the cooling fins, a cooling fluid, such as air, water or oil, is moved past the second portion of the cooling fins in order to cool the cooling fins and thus the battery cells as well. Disadvantageously, improved cooling of the interior of the battery cells is not possible in this way.

It is also known to cool and/or heat the batteries disposed in a battery module with a tempering fluid. For that purpose, the battery module housing has one inlet opening and one outlet opening, through which openings the tempering fluid, in particular air, is passed by means of a delivery device, such as a blower. In the batteries, especially lithium-ion batteries, tempering can thus be done only on the outside in the vicinity of the housing of batteries. As a result, in the interior of the batteries high temperatures can disadvantageously arise, since the electrolyte in the interior of the batteries is a poor thermal conductor. As a consequence of the thermal processes that take place, a sharp increase in temperature occurs, especially a high charging or discharging rates per unit of time and/or for instance high outdoor temperatures. This temperature increase occurs especially in the central region of the battery, since heat can hardly be dissipated there. As a result of this kind of unimpeded temperature development, activation temperatures for chemical processes that are dangerous in terms of safety can be reached, leading under some circumstances to what is called “thermal runaway”. As a chain process, thermal runaway leads to the irreversible destruction of the battery, with an uncontrollable potential risk to the surroundings of the threatened batteries, especially the batteries that are disposed in the immediate surroundings of the threatened battery in the battery module. On the other hand, in operation of the batteries or battery module at low temperatures, for instance in motor vehicles in the winter, it is necessary to heat the batteries to a certain minimum cell temperature. Because of the poor thermal conducting properties of the electrolyte in the interior of the battery, it is difficult, or takes a very long time, to reach an adequate minimum temperature in the central region of the battery. The tempering fluid can also be used for heating the battery, so that when a fluid at a high temperature is passed through in order to heat the battery, it disadvantageously takes a long time, because of the thermal insulating capacity, until an adequate minimum temperature is present in the central region of the battery.

### DISCLOSURE OF THE INVENTION

### Advantages of the Invention

A battery according to the invention includes a housing for receiving at least one electrolyte, and at least one electrolyte received by the housing, in which in the at least one battery, at least one thermal conduction element is disposed, in order to increase the thermal conductivity inside the at least one battery. Advantageously, with the thermal conduction element, heat can be conducted well from a central region of the battery to an external region of the battery, especially in the vicinity of the housing, and vice versa, so that as a result the thermal conductivity inside the battery is increased, and because of that only slight differences in temperature occur inside the battery. As a result, in the central region of the battery, there are no longer any major temperature increases, and on the other hand, upon heating of the battery, a rapid temperature increase can be attained in the central region.

In particular, the at least one thermal conduction element is connected thermally and/or mechanically to the housing. The battery housing, which is generally made from metal, serves among other purposes to transfer the heat from the tempering fluid to the electrolyte and vice versa inside the battery or inside devices that are disposed inside the housing. As a result, the entire interior of the battery can be heated and cooled essentially uniformly.

In a further feature, the at least one thermal conduction element penetrates the housing and protrudes out of the housing. As result, the thermal conduction element can be in direct contact with a tempering fluid for cooling and/or heating the battery.

Preferably, the at least one thermal conduction element is rodlike or platelike. A rodlike conduction element makes it possible to dispose that element centrally in the vicinity of the battery and as a result to temper the especially critical region in the interior of the battery well.

In an additional embodiment, the at least one thermal conduction element connects two opposed walls of the housing together, in particular thermally and/or mechanically.

Preferably, the battery is a lithium-ion battery.

In a variant, the at least one battery is essentially a body of rotation, in particular a cylinder.

Expediently, the at least one thermal conduction element is disposed in a rotary axis of the at least one battery. Because of the disposition in the rotary axis, or in other words centrally, the thermal conduction element can temper the especially temperature-critical central region well at a great distance from the housing of the battery.

In a further feature, the at least one thermal conduction element is disposed centrally in the at least one battery.

In particular, the at least one thermal conduction element at least partly comprises a material having a thermal conductivity in W/mK of at least 1, preferably at least 10, and in particular at least 80.

In a further feature, the at least one thermal conduction element has an electrically insulating coating, for instance of plastic or Teflon, Kalrez, Parafluor or Nafion.

In an additional variant, the at least one thermal conduction element at least partly comprises metal.

In a further variant, the at least one thermal conduction element includes the following substances: silicon and/or aluminum and/or copper and/or magnesium and/or carbon and/or graphite and/or zinc and/or platinum and/or tin.

A battery module of the invention includes a battery module housing, at least one battery disposed in the battery module housing, and at least one means for tempering, that is, heating and/or cooling, the at least one battery, in which the battery is embodied in accordance with a battery described in this application.

In a further feature, at least one battery, independently of at least one other battery, is temperable by means of the at least one thermal conduction element, in particular in that the at least one thermal conduction element of the at least one battery is contactable with a tempering fluid, without the at least one thermal conduction element of the at least one other battery being contactable with the tempering fluid. The at least one thermal conduction element is contactable indirectly or directly with the tempering fluid for cooling and/or heating the at least one battery. The tempering fluid is stored for instance in a container for the purposeful cooling and/or heating of at least one individual battery cell and is put in contact as needed with the at least one thermal conduction element. For that purpose, the container with the tempering fluid is for instance moved toward the at least one thermal conduction element. By means of at least one sensor, the temperature of the at least one battery is measured, and as needed, at least one battery is purposefully tempered by a control unit.

A motor vehicle according to the invention includes at least one battery described in this application and/or at least one battery module described in this application.

In an additional variant, the battery is not a high-temperature battery.

Preferably, the battery is a nickel-cadmium battery or a nickel-metal hydride battery.

In an additional embodiment, the battery includes a positively chargeable electrode and a negatively chargeable electrode.

In a further feature, at least one means for tempering, that is, heating and/or cooling, the at least one battery includes at least one inlet opening for introducing a tempering fluid into the battery module housing and at least one outlet opening for carrying the tempering fluid out of the battery module housing.

Expediently, the at least one means for tempering the at least one battery includes a delivery device, such as a blower, for passing the tempering fluid, such as air, through the battery module.

In an additional feature, the at least one battery of the battery module is not a high-temperature battery.

### BRIEF DESCRIPTION OF THE DRAWINGS

One exemplary embodiment of the invention will be described in further detail below in conjunction with the accompanying drawings. In the drawings:

FIG. 1 is a schematic longitudinal section through a battery with a thermal conduction element;

FIG. 2 is a schematic cross section through the battery of FIG. 1;

FIG. 3 is a schematic longitudinal section through the thermal conduction element;

FIG. 4 is a highly schematic cross section through a battery module having the batteries of FIGS. 1 and 2; and

FIG. 5 is a side view of a motor vehicle.

### EMBODIMENTS OF THE INVENTION

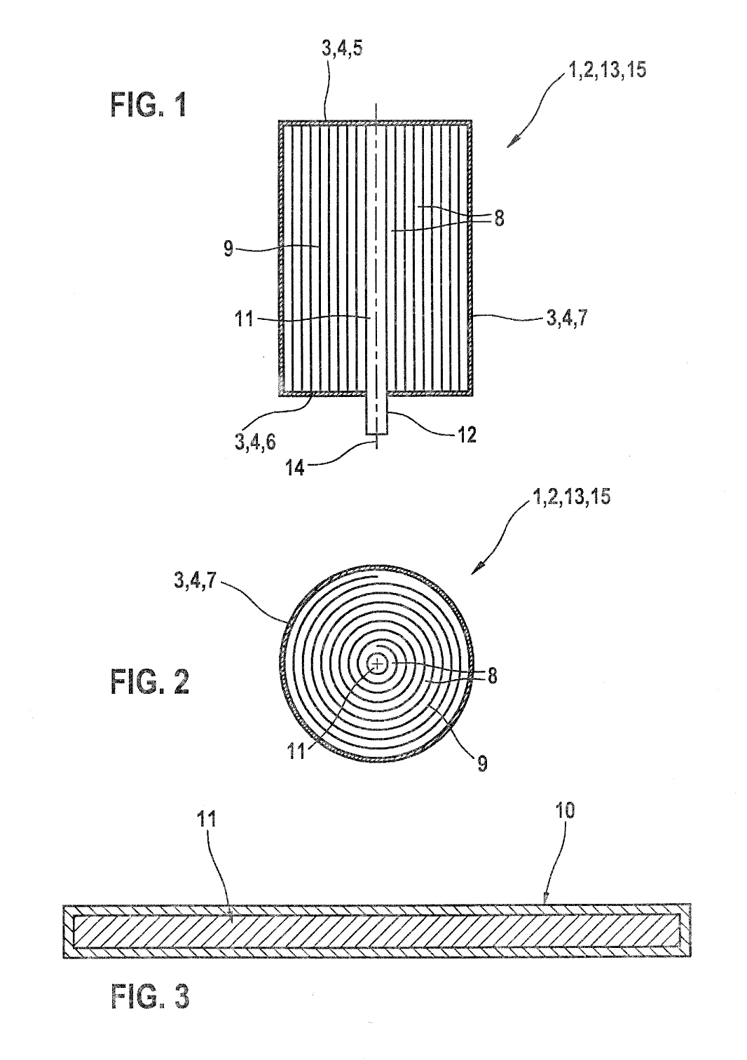

In FIGS. 1 and 2, a longitudinal section and a cross section of a battery 1 embodied as a lithium-ion battery 2 are shown. The battery 1 includes a housing 3 for receiving at least one electrolyte 8. The electrolyte 8 in the case of lithium-ion batteries 2 is generally various organic substances. The housing 3 comprises walls 4 with a top wall 5, a bottom wall 6, and a side wall 7. The top and bottom walls 5, 6 are disklike or circular. Inside the housing 3 is a spirally wound cell coil 9 (FIGS. 1 and 2), which serves among other purposes to receive the electrolyte 8. The battery 1 is a cylinder 15, embodied as a body of rotation 13, with a rotary axis 14. A rodlike thermal conduction element 11 is disposed centrally in the battery 1, that is, in the rotary axis 14 of the battery 1 or of the body of rotation 13.

The rodlike thermal conduction element 11 has a high thermal conductivity and a high electrical insulating capacity. To achieve the high electrical insulating capacity, the thermal conduction element 11 is provided with a coating 10 of plastic (FIG. 3). As material for the thermal conduction element 11, copper or aluminum, for instance, can be considered. For producing the coating 10, plastics can be used, for instance, such as Teflon, Kalrez (perfluor rubber (FFKN, FFPM), Parafluor or Nafion. Still other plastics or polymer compounds can be used for the coating 10 as well. The thermal conduction element 11 is connected thermally and mechanically to the top wall 5 and also penetrates the bottom wall 6 of the housing 3. Thus the thermal conduction element 11 is connected thermally and mechanically to two opposed walls 6, 7 of the housing 3. In the vicinity of the top wall 5 of the housing 3, there is a safety valve (not shown), which in the event of an overpressure inside the housing 3 can allow gases or vapors produced to escape from the housing 3. The thermal conduction element 11 penetrates the housing 3 in the vicinity of the bottom wall 6 and is extended through the bottom wall 6, so that a portion of the thermal conduction element 11 is disposed outside the housing 3, as a connection 12 for tempering the battery 1. The connection 12 thus serves to heat and/or cool the battery 1. The penetration point of the thermal conduction element 11 at the bottom wall 6 is sealed off fluid-tight fashion from the outside. Thus the thermal conduction element 11 overall increases the thermal conductivity inside the battery 1. Because of the high thermal conductivity of the thermal conduction element 11 and because of the thermal communication between the housing 3 and the thermal conduction element 11, or in other words between the top wall 5 and bottom wall 6 and the thermal conduction element 11, the surface area of the housing 3 can be utilized to enable adequate tempering of the battery 1 in the central region of the battery 1. In particular, the electrolyte 8 (FIGS. 1 and 2) disposed around the thermal conduction element 11 and the cell coil 9 disposed spirally around the thermal conduction element 11 can thus be tempered well in the central region. In the production of the battery 1, the cell coil 9 is wound around a cell mandrel and, in the production method known from the prior art, removed after being wound up. Advantageously, in the battery 1 of the invention, the thermal conduction element 11 can be used as a cell mandrel for winding up the cell coil 9 and no longer needs to be removed after the coil has been wound.

The heat produced in the central region of the battery 1 by thermal chemical processes can thus be well diverted outward to the housing 3 and the connection 12 by means of the rodlike thermal conduction element 11. In this way, a dangerous temperature development in the central region of the battery 1 is prevented, because the battery 1 can be well cooled in the central region as well by means 18 for tempering the battery 1. For heating the battery 1 as well, the thermal conduction element 11 can be well used. When a fluid, such as air, bathes the housing 3 of the battery 1, the fluid heats the housing 3 and the connection 12, which because of the good thermal conductivity of the thermal conduction element 11 conduct the heat into the central region of the battery and as a result heat this critical region of the battery 1 equally well. It is thus possible for the central region of the battery and thus essentially the entire battery to be heated and/or cooled essentially uniformly.

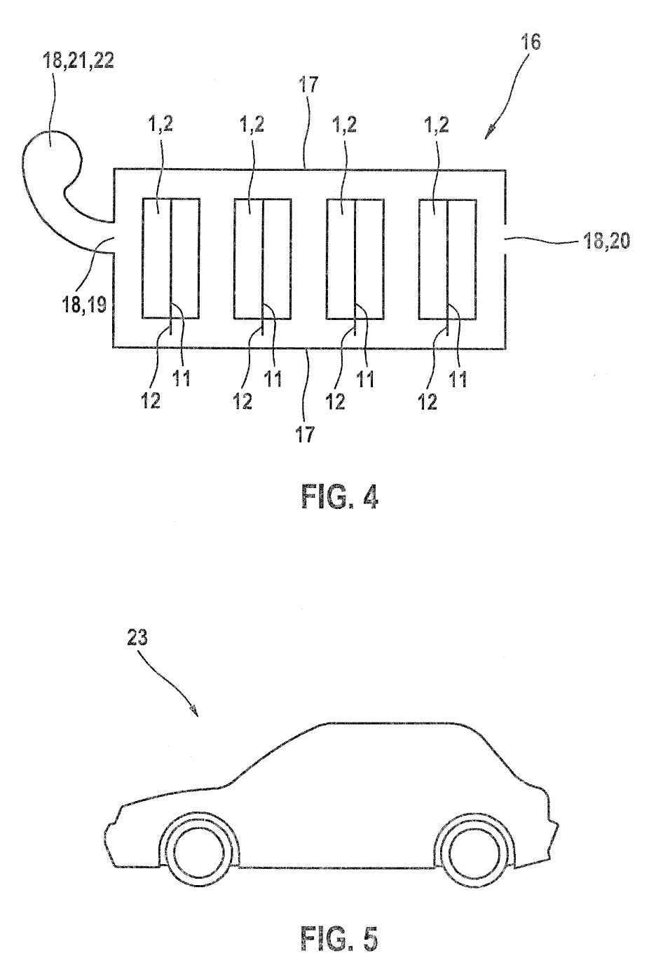

A plurality of batteries 1 can also be disposed in a battery module 16 (FIG. 4). The battery module 16 has a battery module housing 17 with an inlet opening 19 for introducing a tempering fluid, such as air, and an outlet opening 20 for carrying the tempering fluid out of the battery module 16. The tempering fluid is passed through the battery module 16 by means of a delivery device 21 embodied as a blower 22. The blower 22, the inlet opening 19 and outlet opening 20, and the tempering fluid are thus means 18 for tempering the battery 1. Such battery modules 16 can be used particularly in a motor vehicle 23 (FIG. 5). In particular, the motor vehicle 23 is a motor vehicle 23 with a hybrid drive system. The hybrid drive system has an internal combustion engine and an electrical machine (not shown) for driving the motor vehicle 23.

The details of the various exemplary embodiments can be combined with one another unless anything to the contrary is said.

Taken all in all, substantial advantages are associated with the battery 1 of the invention and the battery module 16 of the invention. A thermal conduction element 11 disposed in the interior of the battery 1 increases the thermal conductivity inside the battery 1. The thermal conduction element 11 is disposed in the central region of the battery 1 and is thermally connected to the housing 3. As a result, a fluid for cooling and/or heating the battery can provide good cooling for not only the outer region but advantageously also the central region inside the battery 1, so that a high temperature increase in the central region is prevented, and as a result a dangerous thermal runaway of the battery 1 can be averted. Moreover, the central region can also be heated well, which is advantageous particularly in use in a motor vehicle, if the motor vehicle 23 is to be driven by the battery 1 or the battery module 16 at low temperatures. Especially in motor vehicles 23 with a hybrid drive system or an electric drive system in the winter, this is a decisive advantage for the reliable operation of the hybrid drive system or electric drive system.

1-15. (canceled)

16. A battery, comprising:
a housing for receiving at least one electrolyte;
at least one electrolyte received by the housing; and
at least one thermal conduction element is disposed inside the at least one battery, wherein the at least one thermal conduction element increases thermal conductivity in the battery.

17. The battery as defined by claim 16, wherein the at least one thermal conduction element is connected thermally and/or mechanically to the housing.

18. The battery as defined by claim 16, wherein the at least one thermal conduction element penetrates the housing and protrudes out of the housing, and/or the at least one thermal conduction element is rodlike or platelike.

19. The battery as defined by claim 17, wherein the at least one thermal conduction element penetrates the housing and protrudes out of the housing, and/or the at least one thermal conduction element is rodlike or platelike.

20. The battery as defined by claim 16, wherein the at least one thermal conduction element connects two opposed walls of the housing together, in particular thermally and/or mechanically.

21. The battery as defined by claim 17, wherein the at least one thermal conduction element connects two opposed walls of the housing together, in particular thermally and/or mechanically.

22. The battery as defined by claim 18, wherein the at least one thermal conduction element connects two opposed walls of the housing together, in particular thermally and/or mechanically.

23. The battery as defined by claim 19, wherein the at least one thermal conduction element connects two opposed walls of the housing together, in particular thermally and/or mechanically.

24. The battery as defined by claim 16, wherein the battery is a lithium-ion battery.

25. The battery as defined by claim 16, wherein the at least one battery is essentially a body of rotation, in particular a cylinder.

26. The battery as defined by claim 16, wherein the at least one thermal conduction element is disposed along a rotary axis of the at least one battery.

27. The battery as defined by claim 16, wherein the at least one thermal conduction element is disposed centrally in the at least one battery.

28. The battery as defined by claim 16, wherein the at least one thermal conduction element at least partly comprises a material having a thermal conductivity of at least 1 W/mK, at least 10 W/mK, or at least 80 W/mK.

29. The battery as defined by claim 16, wherein the at least one thermal conduction element has an electrically insulating coating, for instance of plastic or Teflon®, Kalrez®, Parafluor®, or Nafion®.

30. The battery as defined by claim 16, wherein the at least one thermal conduction element at least partly comprises metal.

31. The battery as defined by claim 16, wherein the at least one thermal conduction element includes the following substances: silicon and/or aluminum and/or copper and/or magnesium and/or carbon and/or graphite and/or zinc and/or platinum and/or tin.

32. A battery module, comprising:
a battery module housing;
at least one battery disposed in the battery module housing; and
at least one thermal conduction element which tempers the at least one battery, wherein the battery is embodied in accordance with claim 16.

33. The battery module as defined by claim 32, wherein at least one battery, independently of at least one other battery, is temperable by the at least one thermal conduction element, and wherein the at least one thermal conduction element of the at least one battery is contactable with a tempering fluid, without the at least one thermal conduction element of the at least one other battery being contactable with the tempering fluid.

34. A motor vehicle which includes at least one a battery module as defined by claim 32.

35. A motor vehicle which includes at least one battery as defined by claim 16.
